(19) United States
(12) Patent Application Publication
(10) Pub. No.: US 2021/0027356 A1
(43) Pub. Date: Jan. 28, 2021

(54) SYSTEM AND METHOD FOR USING A CAMERA IMAGE TO PROVIDE E-COMMERCE RELATED FUNCTIONALITIES

(71) Applicant: W.W. Grainger, Inc., Lake Forest, IL (US)

(72) Inventors: Fouad Bousetouane, Vernon Hills, IL (US); Erwin Cruz, Hoffman Estates, IL (US); Jean-Marc Francois Reynaud, Chicago, IL (US); Thomas Allen Mathis, Tolono, IL (US); Geoffry A. Westphal, Evanston, IL (US)

(21) Appl. No.: 16/938,387

(22) Filed: Jul. 24, 2020

Related U.S. Application Data
(60) Provisional application No. 62/878,834, filed on Jul. 26, 2019.

(51) Int. Cl. G06Q 30/06; G06F 16/9532; G06F 16/955; G06K 9/00

(52) U.S. Cl. CPC G06Q 30/0627; G06Q 30/0643; G06K 9/00744; G06F 16/955; G06F 16/9532

(57) ABSTRACT

A computer vision system, which can accurately, quickly, and simultaneously identify multiple SKUs and SKU categories from multiple images taken at a customer's location and that will allow a customer and/or a sales representative to quickly create definitive lists of SKUs and SKU categories that a target vendor sells.

### RELATED APPLICATION INFORMATION

This application claims the benefit of U.S. Provisional Patent Application No. 62/878,834, filed on Jul. 26, 2019, the disclosure of which is incorporated herein by reference in its entirety.

### BACKGROUND

In eCommerce, increasing the number of SKUs and categories from which a customer buys is a difficult challenge. Traditional marketing techniques take time to be effective. The vendor has to make many educated guesses as to what SKUs a customer might be interested in purchasing. Traditional marketing like emails and general and specialty catalogs (paper and electronic) work, but often have the corresponding, traditional sales growth path one sees with these marketing techniques. Moreover, traditional catalogs contain massive amounts of noise, making it time consuming and impractical for a customer to identify what products to purchase. In some companies with sales representatives, the representatives can assist with traditional marketing techniques by being at the customer location and engaging in pointed conversations. However, the effectiveness of a sales representative increasing the sales of a customer depends on many factors: tenure of the representative, knowledge of the representative within various product categories, knowledge of competitors' offerings, and just the challenge of getting their arms around their company's millions of SKUs available for sale.

Furthermore, while visual system for identifying products are generally knows (e.g., U.S. Pat. No. 9,613,283 and US Publication No. 2018/0293256, the disclosures of which are incorporated herein by reference in their entirety), a need exists for a visual system that functions to quickly identify a large numbers of SKUs a customer is already buying to run their business and that would accordingly provide for a different type of relationship between customers and vendors and create non-trivial sales growth opportunities.

### SUMMARY

The following describes a system that uses techniques that accurately target a larger number of products to a customer and which has a different appeal to a customer than the constant marketing bombardment of a few—and often irrelevant—products at a time. In addition, the following describes a tool which can help a customer consolidate purchases to a given vendor would be valuable. In this regard, it will be appreciated that, in B2B commerce, reducing the number of vendors a customer needs to purchase from (vendor consolidation) often saves the customer time and money. Accordingly, the following contemplates a computer vision system, which can accurately, quickly, and simultaneously identify multiple SKUs and SKU categories from multiple images taken at a customer's location and that will allow a customer and/or a sales representative to quickly create definitive lists of SKUs and SKU categories that a target vendor sells. These lists can be used to create large, personalized, accurately targeted sales opportunities that both the customer and sales representative would otherwise not have known about without an impractical amount of effort. A sales representative and their vendor can now bid on a substantial number of SKUs at one sitting. These (interactive) lists could take the form of, say, a spreadsheet list, or a PDF page, with a quoted price included for the unique SKU identified or for any of several products in the identified SKU product category or categories (e.g., products found in a catalog table, under a catalog index entry, or the like).

While the forgoing provides a general explanation of the subject system and method, a better understanding of the objects, advantages, features, properties and relationships of the thereof will be obtained from the following detailed description and accompanying drawings which set forth illustrative embodiment(s) and which are indicative of the various ways in which the principles of the claimed invention may be employed.

### BRIEF DESCRIPTION OF THE DRAWINGS

For a better understanding of the describes system(s) and method(s), reference may be had to the attached drawings in which:

FIG. 1 is a block diagram illustrating components of an exemplary network system in which the subject method may be employed; and

FIG. 2 is a flow diagram illustrating an example process to provide relevant information to a customer using the system of FIG. 1.

### DETAILED DESCRIPTION

The subject system and method uses an image capable search engine that functions to compare product information contained within an image to product image information contained within a data set where the product image information contained within the data set is further cross-referenced to vendor product information (such as product SKUs, pricing, availability, prior purchase history data, etc.)

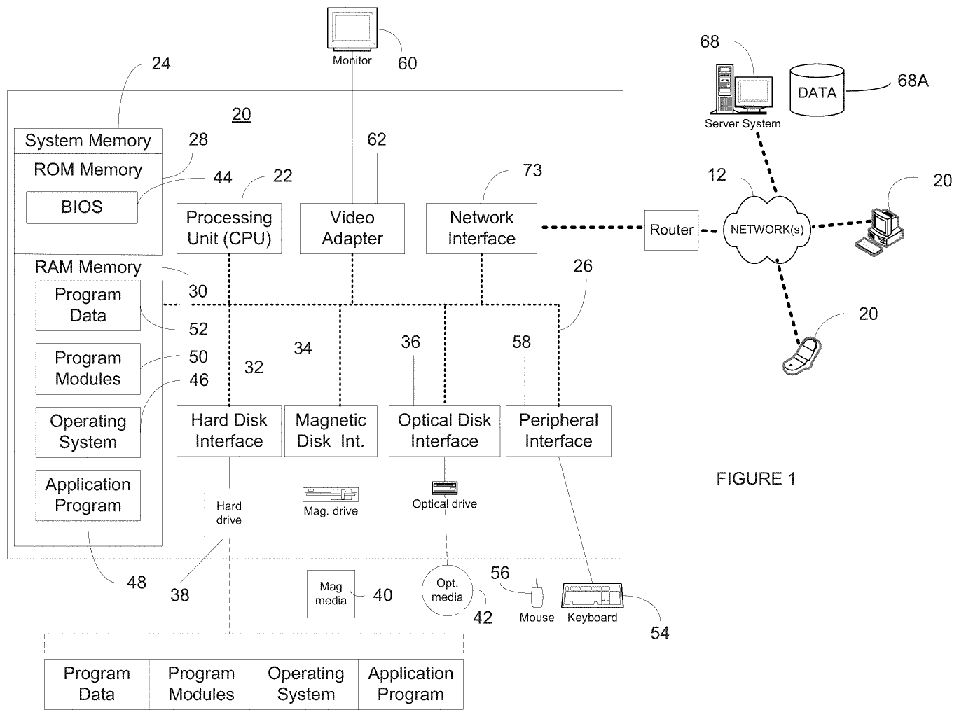

While not intended to be limiting, the subject system and method will be described in the context of a plurality of processing devices linked via a network, such as a local area network or a wide area network, as illustrated in FIG. 1. In this regard, a processing device 20, illustrated in the exemplary form of a device having conventional computer components, is provided with executable instructions to, for example, provide a means for a user to access a remote processing device, i.e., a server system 68, via the network to, among other things, perform a search via use of an intelligent image recognition capable search engine supported by the remote processing device. Generally, the computer executable instructions reside in program modules which may include routines, programs, objects, components, data structures, etc. that perform particular tasks or implement particular abstract data types. Accordingly, those skilled in the art will appreciate that the processing device 20 may be embodied in any device having the ability to execute instructions such as, by way of example, a personal computer, mainframe computer, personal-digital assistant (“PDA”), cellular or smart telephone, tablet computer, or the like. Furthermore, while described and illustrated in the context of a single processing device 20, those skilled in the art will also appreciate that the various tasks described hereinafter may be practiced in a distributed or cloud-like environment having multiple processing devices linked via a local or wide-area network whereby the executable instructions may be associated with and/or executed by one or more of multiple processing devices.

For performing the various tasks in accordance with the executable instructions, the processing device 20 preferably includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a USB interface, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated non-transient, computer-readable media allow for the nonvolatile storage of computer readable instructions, data structures, program modules and other data for the processing device 20. Those skilled in the art will further appreciate that other types of non-transient, computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser, camera, picture editor, etc.), other program modules 50, and/or program data 52. Still further, computer-executable instructions may be downloaded to one or more of the computing devices as needed, for example, via a network connection.

A user may interact with the various application programs, etc. of the processing device, e.g., to enter commands and information into the processing device 20, through input devices such as a touch screen or keyboard 54 and/or a pointing device 56. While not illustrated, other input devices may include a microphone, a joystick, a game pad, a scanner, a camera, a gesture recognizing device, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

The processing device 20 may also utilize logical connections to one or more remote processing devices, such as the server system 68 having one or more associated data repositories 68A, e.g., storing a repository of reference images, a database of product information, etc. In this regard, while the server system 68 has been illustrated in the exemplary form of a computer, it will be appreciated that the server system 68 may, like processing device 20, be any type of device having processing capabilities. Again, it will be appreciated that the server system 68 need not be implemented as a single device but may be implemented in a manner such that the tasks performed by the server system 68 are distributed to a plurality of processing devices linked through a communication network, e.g., implemented in the cloud. Additionally, the server system 68 may have logical connections to other third party server systems via the network 12 as needed and, via such connections, will be associated with data repositories that are associated with such other third party server systems.

For performing tasks, the server system 68 may include many or all of the elements described above relative to the processing device 20. By way of further example, the server system 68 includes executable instructions stored on a non-transient memory device for, among other things, handling search requests, performing intelligent image recognition processing, providing search results, etc. Communications between the processing device 20 and the server system 68 may be exchanged via a further processing device, such as a network router that is responsible for network routing. Communications with the network router may be performed via a network interface component 73. Thus, within such a networked environment, e.g., the Internet, World Wide Web, LAN, or other like type of wired or wireless network, it will be appreciated that program modules depicted relative to the processing device 20, or portions thereof, may be stored in the memory storage device(s) of the server system 68.

To provide search results to a user, the server system 68 will have access to an intelligent and trainable image recognition capable search engine which will attempt to locate likely matches for one or more objects in an image, series of images, and/or a video (hereinafter individually and collectively referred to as an “image”) uploaded to the server system 68. To this end, the image recognition capable search engine may utilize one or more known image recognition techniques, such as wavelet transformation techniques, intensity-based or feature-based techniques, orientation-invariant feature descriptor techniques, scale-invariant feature transformation techniques, etc. to determine if one or more reference images in a library of reference images, e.g., maintained in data repository 68A, matches or is similar to the object(s) in the uploaded image. Because examples of devices adapted to perform image recognition through use of one or more of techniques may be found in US Published Application No. 2009/0161968, U.S. Pat. Nos. 7,639,881, and 5,267,332, among other references, the details of how such devices operate need not be explained in greater detail herein.

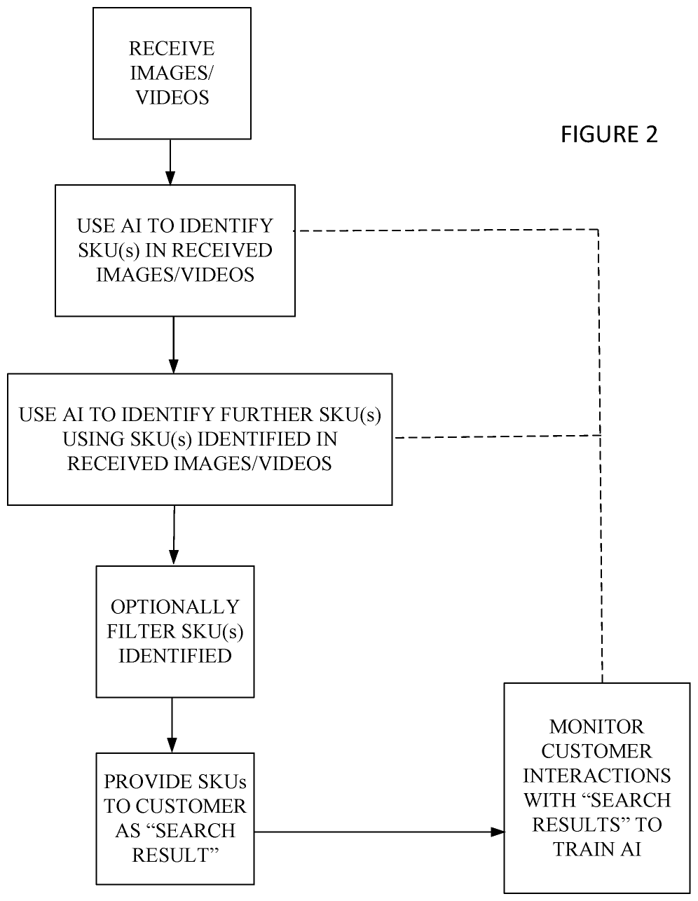

Turing now to FIG. 2, and example process to provide relevant information to a customer using the system of FIG. 1 is illustrated. In the example:

1) the system is provided with product image information, for example by being uploaded from computer 20 to server 68, in the form of input images/videos taken at a customer location;

2) the system uses the product image information to identify one or more vendor SKUs that are seen in the input images/videos (i.e., found by the intelligent image capable search engine within the uploaded data set) and uses the identified vendor SKUs to further identify those SKUs that the customer:

2a) has previously purchased from the vendor in the past; and

2b) has not yet bought from the vendor;

3) the system uses a Community Catalog concept (such as described in U.S. Pat. Nos. 8,781,917, 7,818,218 and/or 7,788,142—each of which is incorporated herein by reference) to identify further vendor SKUs not seen or not recognized by the visual search engine in the product image information provided;

4) the system may apply one or more filters to these variously identified vendor SKUs, e.g., those identified in the image, those identified via use of the Community Catalog concept, etc.;

5) the system creates search results from the filtered, variously identified vendor SKUs;

6) the system provides the created search results to the customer or the vendor customer representative, e.g., the system may create interactive lists/PDFs of those SKUs with quoted/CSP prices which lists may be shared via use of traditional email marketing or the like; and

7) the system uses customer interactions with the search results to train the image recognition search engine for future use in steps 2-4.

With respect to the step of providing the system with product image information in the form of input images/videos taken at a customer location, it is recognized that mobile devices have cameras capable of taking high resolution images. These high-resolution images of many megapixels are of such quality so as to allow the image capable search engine to provide accurate search results. These images can be sent from a vendor mobile app installed on a phone directly to a vendor server, i.e., to the image capable search engine, and the vendor mobile app can receive the search results from the vendor server in real-time or near real time. This app could also allow the customer to select a destination for any captured image(s). For example, the customer could email the image to themselves, send them to one or more of their servers, or place the image in the cloud, allowing the customer (and a 3^{rd} party) to process the images at some point in the future. In another example, the customer could direct the image to be sent to an engineer in a vendor's Technical Support center so a live, interactive discussion can take place. Images can be taken as the customer and/or sales representative move about the facility: workstation by workstation, room by room, closet by closet, service cart by service cart, building by building. Images from multiple vantage points can be taken of the same subject. In this way, it will be more likely that distinguishing characteristics of the subject will be captured and more accurate results returned.

With respect to the step of identifying vendor SKUs via use the provided image, because the image capable search engine is capable of identifying multiple SKUs in a given image, the system can use a single image to present to the customer a table of image search results, each row of the results having one or more SKUs or category tables or links to tables displayed. More particularly, this functionality can be accomplished by having an algorithm start with a cell the size of the screen and performing an image search. A matrix of successively smaller cells can then be placed on top of the image by the algorithm and an image search within each cell can take place. Any given set of cells can be translated over the image to minimize the number of times a subject within the image falls within 2 or more cells. Cells in a matrix do not have to be the same size. Cells in a matrix can be rotated. Cells in a matrix do not have to be square or rectangular. Cells may be, for example, circular for, say, searching for coins, dinner plates, grinding disks, office clocks, or wire brush wheels.

In another implementation, the customer can lasso (rectilinear or free-form) the item(s) in the images for which item search(es) are to be performed simultaneously and then have search results presented in table form.

With respect to using SKUs seen and bought from the vendor, it is to be appreciated that displaying a list of SKU images and letting the customer explore SKU by SKU is just one way a customer can interact with the search results. A click on a SKU can take the customer to an Item Details Page or pop up a Quick View. A UX team may decide that the customer should also have the option to view the items by category (table) with columns of parameters, like in a paper catalog. That columned category table can be built online in real time or be a columned category table which is loaded from a database and originates from a pre-existing PDF vendor catalog page. Moreover, the entire catalog PDF page that contains the category table can also be displayed. There can be active links in any of these columned table examples. In this way, merchandising can take place, giving the customer more options to find the best fit SKU for their needs.

With respect to interacting with an SKU, it is contemplated that a customer can interact with the UI to purchase a SKU (place it in a shopping cart) or, for example, place it in a personal list. Additionally, a customer can interact with the UI to email the SKUs Item Detail Page (“IDP”) to someone or watch a video of the product in use. In short, a customer should be able to interact with the UI to perform any functionality that exists on a conventional IDP.

In an example, an indication for each “matching” SKU can be displayed showing that the customer's input image has one or more objects likely already been purchased from a category or as an exact SKU match from the vendor. The vendor can use the customer order history database to help determine this, since the identity of the customer can be known. That is not to say, however, that the image search tool cannot be used anonymously, albeit with less functionality.

With respect to the step of identifying SKUs seen and not bought from the vendor, the customer can be made aware that they have likely purchased the matching SKU, or a matching SKU in a product category, from another vendor but that the vendor also sells an exact match or a functional equivalent for an identified product. For example, the visual search algorithm may successfully detect a D battery. However, the D battery in the customer's input image is branded “Eveready” and the D batteries that the vendor carries are branded “Duracell.” Again, the customer order history databases come in handy here to verify that the customer has yet to purchase “Duracell” branded batteries from the vendor. An indication on a particular SKU or category table can inform the customer that the vendor sells a particular SKU, or set of SKUs from a category table, and that the customer has an opportunity to buy these items from the vendor and start consolidating their purchases by buying more from the vendor and thus reducing procurement costs.

With respect to the step of identifying vendor SKUs not seen in any of the images, it is to be understood that, even if a sales representative and/or a customer has taken multiple images around their facilities, it is possible that not all MRO items showed up in these images. In this case, knowing information about the customer's role and title, for example, or information about the type of business the customer is in, using the Community Catalog concept (e.g., as disclosed in US 2019/0087887, US 2010/0223064, and US 2009/0216660—the disclosures of which are incorporated herein by reference in their entirety), the vendor can recommend products that the customer is likely buying. As before, some of these unseen products may have been bought previously from the vendor, others from competitors, and still others not purchased at all. Again, the order history databases can help determine what SKUs to recommend (e.g., SKUs that were not seen in the image and that do not show up in the order history).

With respect to the step of using filters when image searching for SKUs, it is contemplated that a community-based filter could be used to highlight matching SKUs or categories of SKUs. Other filters might include filters that highlight (or restrict from display) SKUs that have been identified but which require authorization for purchase, that highlight SKUs that are currently in a near-by vending machine (QTY available could be displayed) or in a near-by tool crib (with bin location displayed). Still further, other filters that can be preset before an image search is performed could be filters that highlight (or restrict from display) SKUs that are used by a particular user or SKUs above or below a certain price threshold. Still more filters could include indication of private label or items that are now discontinued.

With respect to the step of creating search results, it is to be understood that, during the image search process, SKUs that are likely exact matches or functional equivalents are identified. In other words, the match is exactly one SKU. OCR (optical character recognition) may play a role here, along with colors and trade dress. In other cases, only the category of a target image may be discerned (e.g., flat head screwdriver). In cases where multiple SKUs are matched in one image, duplicate SKUs and duplicate product categories (catalog tables) are removed. A table of results are presented to the customer (or generic user). A row of search results, where a row corresponds to match(es) for one object discerned in an uploaded image, may have only one SKU or only one category. Other search result rows may have multiple SKUs or one or more multiple categories (e.g., safety shoes: anti-slip & steel toed). There are numerous options for displaying search results. This disclosure assumes a row-like structure, with one of more matching SKUs and/or product categories possible in each row.

In some instances, it may be desirable to create interactive lists wherein SKU images (or SKU identifying text) in a search result are active links to an Item Details Page, i.e., clicking on or otherwise selecting the link will direct a browser, app, etc. to the Items Detail Page. Categories in the search results may also be links. Clicking on a category (text) link can, say, pop-up a window with a real-time generated list of SKUs, the SKUs again being links. The SKUs in this list are all related: they are in a category. This category can be created in real-time based on product hierarchies, or the categories can be represented by a table that show up on a page of a PDF file, the PDF file representing a page in a paper catalog, magalog, flier, etc. Whether a search results row has only SKUs, only categories, or a mixture of both, a feature can expand the entire row into a super row, which only SKUs are listed corresponding to the SKUs and SKUs contained in the categories. In this way, individual SKUs can be checked and added to a shopping cart, all the SKUs in the super row corresponding as a match to the subject in an input image. In the case of multiple images input to the system, multiple interactive lists may be created.

It is also contemplated that interactive lists would also contain prices. One possible use case is to be able to aggregate a large number of SKUs discerned through images at a customer location so that an en masse quote can be made. Having an ability to interact with a customer in this way currently does not exist. Instead of conversations between sales representatives and individual customers, a conversation can take place with a purchasing director where wholesale changes to the relationship between the customer and the vendor can occur. Customer specific pricing (quotes) can be displayed in the search results, the pricing corresponding to, for example, the situation where the customer purchases different percentages of new items (not previously purchased from the vendor) in the search results. Another way of quoting a customer is by how many items within a category a customer is buying and discounting only those items.

While the foregoing describes actions that take place in a browser or on a mobile app, it will also be appreciated that interactive lists can be created in a batch process, for example taking advantage spreadsheet programming.

Another way of creating lists is by aggregating the PDF files that correspond to and contain the SKUs and categories in the search results. This is a useful way of merchandising. It gives the customer (user) a better view of what the vendor has to offer. Pre-existing electronic PDF pages also have product recommendations and upsell SKUs. Literally, as a video is being taken while walking through a customer's facilities, a dynamic PDF file containing the SKUs and categories can be created in real-time. This is a custom catalog, for that customer. Each and every PDF page will necessarily contain highly relevant SKUs and product information. Buying SKUs using this PDF file will be much more efficient than using a general paper catalog. The SKUs on the PDF pages could be active links.

Moreover, one or more lists created can be used to create a filter through which subsequent online website search results are passed. Instead of having millions of products to search from, a search for screwdrivers will result in only the categories and SKUs that matched to the submitted target images containing screwdrivers. Multiple filters can exist for, say, different individuals at a customer's location, or for different buildings, etc. Customers would be able to select which filter they want to use when they are searching the vendor website.com or the vendor mobile app in regular SKU search mode. Search results created via use of uploaded image(s) can be maintained for a customer and the customer can be give the opportunity to select one or more of these prior search results for use in creating the filter.

In the case where SKUs and item categories are identified that the customer is not buying from the vendor, this information can be used to drive extremely on-target email campaigns to a given company or given individual users in a company.

With respect to the step of sending information to retrain the neural networks when customers interact with the search results, the vendor can track what items customers are looking at and what items customers eventually buy, for example, after they lasso an item and/or select one or more items in the visual search results. Along with customer demographic information, customer past buying patterns, customer firmagraphics, the physical location of the customers facilities, customer SIC, the customer community, etc., this information can be used as additional input to help train the neural networks that perform the visual search.

In providing search results, it is also contemplated that additional UI features may be included. Possible UI features include the ability to have an input image on one part of the screen and the search results on another part of the screen. SKUs that were either lassoed by the customer or SKUs that were identified by the automatic cell-matrix technique can be highlighted in some fashion, say, with a dotted-line box surrounding the SKU. When the customer clicks on the SKU box in the image, the corresponding SKU or category within which the SKUs likely exists can be highlighted in the search results. Likewise, the reverse is also possible. Namely, when a customer clicks on a unique SKU in the search results or a SKU contained within a category in the search results, the corresponding dotted-line box that encompasses the SKU in the submitted image can be highlighted in some manner.

While various concepts have been described in detail, it will be appreciated by those skilled in the art that various modifications and alternatives to those concepts could be developed in light of the overall teachings of the disclosure. For example, while described in the context of a networked system, it will be appreciated that the visual search engine functionality can be included on the search query receiving computer itself. Further, while various aspects of this invention have been described in the context of functional modules and illustrated using block diagram format, it is to be understood that, unless otherwise stated to the contrary, one or more of the described functions and/or features may be integrated in a single physical device and/or a software module, or one or more functions and/or features may be implemented in separate physical devices or software modules. It will also be appreciated that a detailed discussion of the actual implementation of each module is not necessary for an enabling understanding of the invention. Rather, the actual implementation of such modules would be well within the routine skill of an engineer, given the disclosure herein of the attributes, functionality, and inter-relationship of the various functional modules in the system. Therefore, a person skilled in the art, applying ordinary skill, will be able to practice the invention set forth in the claims without undue experimentation. It will be additionally appreciated that the particular concepts disclosed are meant to be illustrative only and not limiting as to the scope of the invention which is to be given the full breadth of the appended claims and any equivalents thereof.

What is claimed is:

1. A non-transient, computer-readable media having stored thereon instruction, wherein the instructions, when executed by a processing device, perform steps for creating a search result for provision to a customer by a vendor, the steps comprising:
using an image capable search engine to identify one or more objects within an image;
using the one or more objects identified within the image to identify within a database of product information a first set of product information, the first set of product information being information about product, sold by the vendor, which is an exact match and/or similar to the one or more objects identified within the image;
using the first set of product information in combination with information associated with the customer to identify within the database of product information a second set of product information, the second set of product information being information about product, sold by the vendor, which is not an exact match and/or similar to any of the one or more products identified within the image;
creating the search result from both the first set of product information and the second set of product information; and
causing the search result to be downloaded to an end-user device.

2. The non-transient, computer-readable media as recited in claim 1, wherein the information associated with the customer comprises information representative of a location associated with the customer at which the image was captured.

3. The non-transient, computer-readable media as recited in claim 1, wherein the information associated with the customer comprises a business type for the customer.

4. The non-transient, computer-readable media as recited in claim 1, wherein the image comprises a video.

5. The non-transient, computer-readable media as recited in claim 1, wherein the image capable search engine is used to identify one or more objects within the video and the search result is created while the video is being captured.

6. The non-transient, computer-readable media as recited in claim 1, wherein the first set of product information and the second set of product information are filtered to create the search result.

7. The non-transient, computer-readable media as recited in claim 1, wherein the instructions, when executed by the processing device, perform the further step of monitoring user interactions with the search result for training at least the image capable search engine.

8. The non-transient, computer-readable media as recited in claim 1, wherein the instructions, when executed by the processing device, perform the further step of converting the search result into a filter for use by a customer in connection with a subsequently provided request to search a product database associated with the vendor.

9. The non-transient, computer-readable media as recited in claim 1, wherein the first set of product information comprises one or more images of products sold by the vendor.

10. The non-transient, computer-readable media as recited in claim 1, wherein the first set of product information comprise one or more activable links to one or more product detail pages for one or more products sold by the vendor.

11. The non-transient, computer-readable media as recited in claim 10, wherein the activable links comprise an alphanumeric stock keeping identifier associated with the one or more products.

12. The non-transient, computer-readable media as recited in claim 10, wherein the first set of product information comprise one or more activable links to one or more electronic catalog pages having one or more products sold by the vendor.

13. The non-transient, computer-readable media as recited in claim 1, wherein the second set of product information comprises one or more images of products sold by the vendor.

14. The non-transient, computer-readable media as recited in claim 1, wherein the second set of product information comprise one or more activable links to one or more product detail pages for one or more products sold by the vendor.

15. The non-transient, computer-readable media as recited in claim 14, wherein the activable links comprise an alphanumeric stock keeping identifier associated with the one or more products.

16. The non-transient, computer-readable media as recited in claim 14, wherein the first set of product information comprise one or more activable links to one or more electronic catalog pages having one or more products sold by the vendor.

17. The non-transient, computer-readable media as recited in claim 1, wherein the search results visually distinguish between information from the first set of product information and the second set of product information.
